(19) United States
(12) Patent Application Publication
(10) Pub. No.: US 2016/0341372 A1
(43) Pub. Date: Nov. 24, 2016

(54) LED LAMP CAPABLE OF FREELY CONVERTING COLOR TEMPERATURE AND METHOD FOR CONVERTING COLOR TEMPERATURE USING THE SAME

(71) Applicant: STCUBE, INC., Seoul (KR)

(72) Inventor: Hyun-Seop SHIM, Seoul (KR)

(21) Appl. No.: 14/777,651

(22) PCT Filed: May 22, 2015
(86) PCT No.: PCT/KR2015/005170

§ 371 Date: Sep. 16, 2015

(51) Int. Cl. F21K 99/00; F21V 14/08; F21V 5/04; F21V 29/83; F21V 29/89; F21V 9/16; F21V 29/70

(52) U.S. Cl. CPC F21K 9/58; F21V 9/16; F21K 9/56; F21V 14/08; F21V 29/70; F21V 29/83; F21V 29/89; F21V 5/04; F21Y 2101/02

(57) ABSTRACT

The present invention relates to an LED lamp capable of freely converting color temperature and a method for converting color temperature using the same. The LED lamp may include a single-color or white LED, a fixed filter, and a color temperature conversion filter. The LED lamp can implement illumination light having a desired color temperature and color rendering property by gradually and reversibly expanding and reducing an overlap region between the fixed filter and the color temperature conversion filter, thereby having high convenience and economic efficiency.

### TECHNICAL FIELD

The present disclosure relates to an LED lamp capable of freely converting color temperature and a method for converting color temperature using the same, and more particularly, to an LED lamp capable of freely converting color temperature, which includes a single-color or white LED, a fixed filter, and a movable filter and is capable of gradually and reversibly expanding/reducing an overlap region between the fixed filter and the movable filter such that a user can implement illumination light having a desired color temperature and color rendering property according to the atmosphere or situation, and a method for converting color temperature using the same.

### BACKGROUND ART

The LED exhibits high light conversion efficiency and low power consumption, has a semi-permanent lifetime and high response speed, and is suitable for reduction in size and weight. Furthermore, since the LED has no flickers, the LED can reduce optic nerve fatigue. In addition, the LED has high resistance to impact, and exhibits an environment-friendly characteristic because the LED does not use discharge gas. Thus, the LED is widely used for vehicle lighting systems or indoor/outdoor lighting system. In particular, as high-brightness LEDs capable of improving the problem of the conventional LED lamps having low brightness are released on the market, the use of the high-brightness LEDs has rapidly expanded.

In particular, since white LEDs are very useful for high-quality indoor/outdoor lighting systems, the use frequency thereof has rapidly increased. Thus, it is expected that the white LEDs will replace fluorescent lamps in the same manner as the fluorescent lamps had removed incandescent lamps, and occupy most of lighting lamps in no distant future.

The white LED may be implemented by directly coating the surface of a single-color LED chip, such as blue LED, purple LED, or ultraviolet (UV) LED, with a fluorescent substance or uniformly dispersing a fluorescent substance in a lens formed by molding a single-color LED chip. The white LED produces white light through mixture of a part of primary light emitted from the single-color LED chip and secondary light having a wavelength converted by the fluorescent substance.

In this method, however, since the surface of the blue LED, the purple LED, or the UV LED is directly coated with a fluorescent substance or a fluorescent substance is mixed and molded on the periphery or lens part of the LED, the heat radiation characteristic of the LED may be degraded to significantly reduce the lifetime of the LED.

As described above, the white LED, which is implemented by coating the single-color LED with a specific single-color fluorescent substance or various types of fluorescent substances or molding a specific single-color fluorescent substance or various types of fluorescent substances, combines 1-wavelength single-color light emitted from the single-color LED with 2 or 3-wavelength compound light generated by excitation of the fluorescent substance, and causes constructive interference such that the light can be recognized as white light by the human eyes.

However, since the white light of the white LED contains 2 or 3-wavelength compound light which is not completely complementary, the white light has only partial spectrums of the visible light range. Thus, the white light typically has a color rendering property of 60 to 75. When the color rendering property is high, the white light exhibits a color rendering property of 75 to 85. Therefore, the white light may not be recognized as satisfactory white light close to natural light.

Examples of factors having an influence on the characteristics of white light emitted from the white LED may include the intensity of light emitted from the LED, the combination suitability between light emitted from the LED and light converted by a fluorescent substance, the composition and content of the fluorescent substance, and the dispersion state of the fluorescent substance. The light emitted from the LED is significantly influenced by the factors. Recently, a warm white LED, a cold white LED, and a natural white LED have been obtained by changing the combination suitability of light converted by a fluorescent substance through a variety of publicly known methods which adjust the composition and content of a fluorescent substance.

In order to obtain a white LED having an excellent light emission characteristic, a fluorescent substance must be uniformly dispersed in transparent matrix resin. During a manufacturing process, however, the fluorescent substance having a high specific gravity precipitates under the transparent matrix resin having a low specific gravity, before the transparent resin is completely hardened. The fluorescent substance has a specific gravity of about 3.8 to 6.0, even though the specific gravity is different depending on the type of the fluorescent substance, and the transparent matrix resin, for example, epoxy resin has a specific gravity of about 1.1 to 1.5. Thus, it is difficult to obtain white light having excellent optical characteristics, and it is not easy to precisely control the dispersion degree of the fluorescent substance and to accomplish a uniform mixture distribution, when two or more kinds of fluorescent substances are mixed and used. Therefore, it is not easy to manufacture a high-quality white LED device, and to obtain satisfactory manufacturing reproducibility.

Furthermore, since a high-power and high-frequency white LED lamp has a high heat radiation characteristic, the optical output characteristic or efficiency thereof is degraded, the lifetime thereof is reduced, and surrounding parts or elements thereof are deteriorated. Thus, it is becoming an important issue to radiate heat using a heat sink or heat spreader. Therefore, in order to improve the heat radiation characteristic of the LED lamp, the heat sink or heat spreader is exposed through the outer surface of the LED lamp, while the size or area of the heat sink or heat spreader is increased. However, in the structure of the white LED which implements white light by directly coating the surface of a blue, purple, or UV LED with a fluorescent substance or uniformly mixing a fluorescent substance in a lens formed through molding, the LED chip is inevitably deteriorated and the lifetime thereof is inevitably reduced, due to the reduction in heat radiation characteristic of the LED chip.

Typical examples of conventional LED lamps capable of converting color temperature may include Korean Patent No. 0723912 (registered on May 25, 2007) and Korea Patent Publication No. 2008-0087242 (published on Oct. 1, 2008). As illustrated in FIG. 31, a plurality of first white LEDs 4a′ and a plurality of second white LEDs 4a″ are distributed and arranged at a proper combination ratio on the bottom surface of a stand head 10′ having a socket 12′ formed at one end thereof in a color temperature conversion LED lamp stand 1′. The first white LED 4a′ emits natural white light having a color temperature of 6,000 to 8,000K, and the second white LED 4a″ emits warm white light having a color temperature of 2,300 to 4,000K. Then, an input current value and the number of LEDs which are turned on among the first and second LEDs 4a′ and 4a″ are controlled to obtain a color temperature and color rendering property desired by a user.

However, in the conventional LED lamp capable of converting a color temperature, various kinds of LEDs having different color temperatures must be mixed and arranged, and an LED having a specific color temperature must be selected and assembled at a specific position. Thus, since the conventional LED lamp has a complex structure, it is no easy to assemble the LED lamp. Furthermore, the LED lamp requires a control circuit and program for selectively turning on/off a predetermined number of LEDs at a specific arrangement and position and changing an input current value. In addition, selection of illumination light having a desired color temperature and color rendering property is limited to a preset value. Furthermore, since the white LED is used, it is difficult to uniformly disperse a fluorescent substance. Since the fluorescent substance applied on the single-color LED degrades the heat radiation characteristic, the lifetime of the LED lap is reduced.

### PRIOR ART DOCUMENT

### Patent Document

1. Korean Patent No. 0723912 (registered on May 25, 2007)

2. Korea Patent Publication No. 2008-0087242 (published on Oct. 1, 2008)

### DISCLOSURE

### Technical Problem

Various embodiments are directed to an LED lamp capable of freely converting color temperature, which can simply and freely convert the color temperature of a single-color or white LED having a specific single color temperature into white light having a desired color temperature, without using a complex combination of LEDs having various color temperatures.

Also, various embodiments are directed to an LED lamp which is capable of providing an improved color rendering property through successive and gradual conversions of color temperature.

Further, various embodiments are directed to an LED lamp which is capable of effectively implementing white light having a color temperature desired by a user, using a simple physical unit without a complex structure or control circuit.

Further, various embodiments are directed to an LED lamp which is capable of simply obtaining white light having a desired color temperature from a high-brightness blue LED, purple LED, or UV LED which has a relatively long lifetime and a low price, without using a high-brightness white LED which has a relatively short lifetime and a high price.

Further, various embodiments are directed to a method for converting color temperature of an LED lamp.

### Technical Solution

In an embodiment, an LED lamp may include: an LED light source module including a fixed filter mounted therein and having a constant color temperature; and a color temperature conversion module including a color temperature conversion filter for gradually expanding or reducing an overlap region between the fixed filter and the color temperature conversion filter. The overlap region between the color temperature conversion filter and the fixed filter may be gradually expanded and reduced to freely convert color temperature.

The LED light source module may include a white LED, a blue LED, a purple LED, or an UV LED.

The fixed filter may be formed of transparent glass, fluorescent coating glass, fluorescent substance-containing molding resin, or fluorescent coating resin, and the color temperature conversion filter may be formed of fluorescent substance-containing molding resin or fluorescent coating resin.

The color temperature conversion filter may have an aperture structure including a plurality of filter pieces.

In an embodiment, an LED lamp may include: an LED light source module including a fixed filter mounted therein and having a constant color temperature; and a color temperature conversion module. The color temperature conversion module may include: an outer heat sink including a web having a first central opening formed therein, a plurality of arc-shaped protrusions formed at an outer edge thereof so as to be spaced from each other, and a plurality of first fixing protrusions formed at an inner edge thereof so as to be spaced from each other; an inner heat sink including: an upper flange having a plurality of arc-shaped horizontal protrusions spaced from each other; an inward flange having a plurality of fixing protrusions spaced from each other, a plurality of arc-shaped guide slots into which the respective arc-shaped protrusions are inserted, and a second central opening formed therein; and a ring-shaped sidewall integrally connecting the inward flange and the upper flange and having one or more vertical protrusions formed therein, wherein the plurality of arc-shaped vertical protrusions are mounted in the outer heat sink so as to protrude to the outside of a rim; a color temperature conversion filter including a plurality of filter pieces to form an aperture structure, wherein each of the filter pieces has a connection protrusion and a hole into which the first fixing protrusion is inserted, and the connection protrusion and the hole are formed at one end of the filter piece; a plurality of links connecting the connection protrusions of the plurality of filter pieces to the plurality of second fixing protrusion, respectively; and a cover having a concave part and a flange formed at the top of the concave part, the concave part having a third central opening formed therein and including one or more saw-tooth parts formed on the outer periphery of the sidewall thereof and, the one or more saw-tooth parts being engaged with the one or more vertical protrusions. The outer heat sink, the cover, and the loop may be fixed together by a fixing unit, the inner heat sink may be forward/backward rotated within the length of the arc-shaped guide slot of the inner heat sink, into which the arc-shaped horizontal protrusion of the outer heat sink is inserted, the forward/backward rotation of the inner heat sink may be precisely adjusted through engagement between the vertical protrusions of the inner heat sink and the saw-tooth parts of the cover, and through an aperture motion of the plurality of filter pieces connected to the first fixing protrusions of the outer heat sink and the second fixing protrusions of the inner heat sink based on the forward/backward rotation of the inner heat sink, an overlap region between the fixed filter of the LED light source module and the color temperature conversion filter of the color temperature conversion module may be gradually expanded and reduced to freely convert color temperature.

The cover may include a rail part having a plurality of arc-shaped guide slots into which the respective first fixing protrusions are inserted and which are spaced from each other, and the rail part is extended downward from the outer periphery of the bottom surface of the concave part and then inward curved.

The loop may be fastened to the top of the cover.

A space may be formed between the outer periphery of the loop and the inner periphery of the flange of the cover.

A plurality of locking bosses may be formed at the bottom of the rim of the outer heat sink.

The LED light source module may include a white LED, a blue LED, a purple LED, or a UV LED.

The fixed filter may be formed of transparent glass, fluorescent coating glass, fluorescent substance-containing molding resin, or fluorescent coating resin, and the color temperature conversion filter may be formed of fluorescent substance-containing molding resin or fluorescent coating resin.

The LED light source module may include a heat sink having a COB (Chip on Board) receiving part, a COB, the fixed filter, and an upper cover.

The heat sink may have a rim and the COB receiving part, the upper cover has a flange and a protrusion having a central opening formed therein, the protrusion may have a plurality of heat radiation holes and one or more engagement holes formed on the outer periphery thereof, the engagement hole including an open end formed at one end thereof and a saw-tooth part formed on the inner top surface thereof and having a height which gradually decreases from the open end toward the inside thereof, and the plurality of locking bosses formed at the bottom of the rim of the outer heat sink of the color temperature conversion module may be inserted into the engagement holes and reliably fixed by the saw-tooth part.

The heat sink may include an inward protrusion having an upper cover fixation hole, a bottom part having a fixation hole formed therein, and a bottom plate.

A lens or reflector serving as a backlight module may be attached to the LED lamp.

The backlight module may include: a bottom plate having a seat part forming a central opening, a rim, a web, and a plurality of through-slots formed in the web adjacent to the rim; a backlight member; and an upper fixing part having a fixing stepped part formed on the upper inner periphery thereof and a plurality of fastening pieces extended downward and fixed to the bottom plate through the plurality of through-slots so as to fix the backlight member.

A plurality of arc-shaped protrusions and locking bosses spaced from each other may be radially formed on the bottom surface of the web of the bottom plate, and the locking bosses may be fastened to the inner bottom surface of the outer periphery of the loop at the same time as the arc-shaped protrusions and the locking bosses of the bottom plate are inserted into the space formed between the outer periphery of the loop and the inner periphery of the flange of the cover.

The backlight module may include a lens, and the lens may have a cross-sectional shape of which the upper part is wide and the lower part is narrow, and includes a hemispherical concave part formed at the bottom thereof and a ring-shaped concave surface including a hemispherical protrusion formed in the top center thereof and having a structure of which the height increases from the outer periphery of the hemispherical protrusion toward the outer peripheral end of the top surface of the lens.

In an embodiment, a method for converting color temperature of an LED lamp may include the steps of: (A) assembling a color temperature conversion module including a color temperature conversion filter into an LED light source module including a fixed filter mounted therein and having a constant color temperature; and (B) implementing illumination light having a desired color temperature by gradually expanding or reducing an overlap region between the fixed filter and the color temperature conversion filter.

The expansion or reduction of the overlap region between the fixed filter and the color temperature conversion filter at the step (B) may be performed through an aperture motion of the color temperature conversion filter.

### Advantageous Effects

In accordance with the embodiments of the present invention, the LED lamp and the method for converting color temperature using the same can simply and freely convert the color temperature of a single-color or white LED having a constant single color temperature into white light having a desired color temperature, using the function of the LED lamp, without using a complex combination of LEDs having various color temperatures. Thus, the LED lamp has high user convenience and economical efficiency, and can provide an improved color rendering property through successive and gradual conversions for the color temperature. The LED lamp can obtain white light having a desired color temperature from a high-brightness blue LED, purple LED, or UV LED which has a relatively long lifetime and a low price, without using a high-brightness white LED which has a relatively short lifetime and a high price. Thus, the LED lamp has high economical efficiency.

### BRIEF DESCRIPTION OF DRAWINGS

FIG. 1 is a perspective view of an LED lamp capable of freely converting color temperature and an assembly module thereof in accordance with an embodiment of the present invention.

FIG. 2 is a perspective view of an LED light source module.

FIG. 3 is a side view of FIG. 2.

FIG. 4 is an exploded perspective view of FIG. 2.

FIG. 5 is a perspective view of a color temperature conversion module.

FIG. 6 is a bottom perspective view of FIG. 5.

FIG. 7 is an exploded perspective view of FIG. 5.

FIG. 8 is a plan view of FIG. 5

FIG. 9 is a side view of FIG. 5.

FIG. 10 is a bottom view of FIG. 5.

FIG. 11 is a partially exploded perspective view of FIG. 5.

FIG. 12 is a partially exploded perspective view of FIG. 5.

FIG. 13 is a perspective view illustrating a state in which a color temperature conversion filter is opened to the maximum.

FIG. 14 is a perspective view illustrating a state in which the color temperature conversion filter is opened to an intermediate position.

FIG. 15 is a perspective view illustrating a state in which the color temperature conversion filter is closed.

FIGS. 16 to 18 are plan views of FIGS. 13 to 15.

FIGS. 19 to 21 are bottom views of FIGS. 13 to 15, illustrating states in which an upper cover is mounted.

FIG. 22 is a perspective view illustrating a process in which an LED light source module and the color temperature conversion module are assembled.

FIG. 23 is a bottom perspective view illustrating a process in which an LED light source module and the color temperature conversion module are assembled.

FIG. 24 is a perspective view illustrating a state in which the LED light source module and the color temperature conversion module are assembled.

FIG. 25 is a perspective view of a backlight module.

FIG. 26 is a bottom perspective view of FIG. 25.

FIG. 27 is an exploded perspective view of FIG. 25 when the backlight module is a lens.

FIG. 28 is an exploded perspective view when the backlight module is a reflector.

FIG. 29 is a perspective view illustrating a state in which the backlight module is assembled.

FIG. 30 is a bottom perspective view illustrating a state in which the backlight module is assembled.

FIG. 31 is a diagram illustrating a conventional LED lamp.

### MODE FOR INVENTION

Hereafter, exemplary embodiments of the present invention will be described in detail with reference to the accompanying drawings.

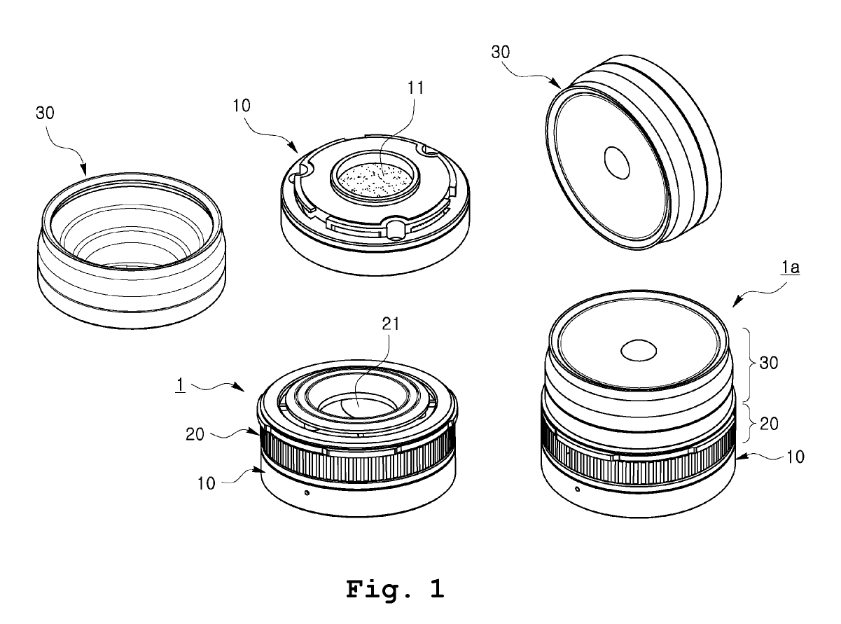

FIG. 1 is a perspective view of an LED lamp capable of freely converting color temperature and an assembly module thereof in accordance with an embodiment of the present invention. As illustrated in FIG. 1, the LED lamp 1 capable of freely converting color temperature in accordance with the embodiment of the present invention includes an LED light source module 10 having a fixed filter 11 and a color temperature conversion module 20 having a color temperature conversion filter 21. In a selected case, the LED lamp la capable of freely converting color temperature may further include a backlight module 30. The backlight module 30 may include a reflector illustrated in the left side of FIG. 1 or a lens illustrated in the right side of FIG. 1.

The LED lamp 1 capable of freely converting color temperature in accordance with the embodiment of the present invention may basically include the LED light source module 10 having the fixed filter 11 mounted therein and the color temperature conversion module 20 having the color temperature conversion filter 21 which can gradually expand and reduce an overlap region between the fixed filter 11 and the color temperature conversion filter 21. In addition, the LED lamp 1 may include the backlight module 30 mounted thereon. As the overlap region between the color temperature conversion filter and the fixed filter 11 is gradually expanded and reduced, the color temperature can be freely converted.

In the embodiment of the present invention, the color temperature conversion filter 21 may form an aperture structure including a plurality of filter pieces 210.

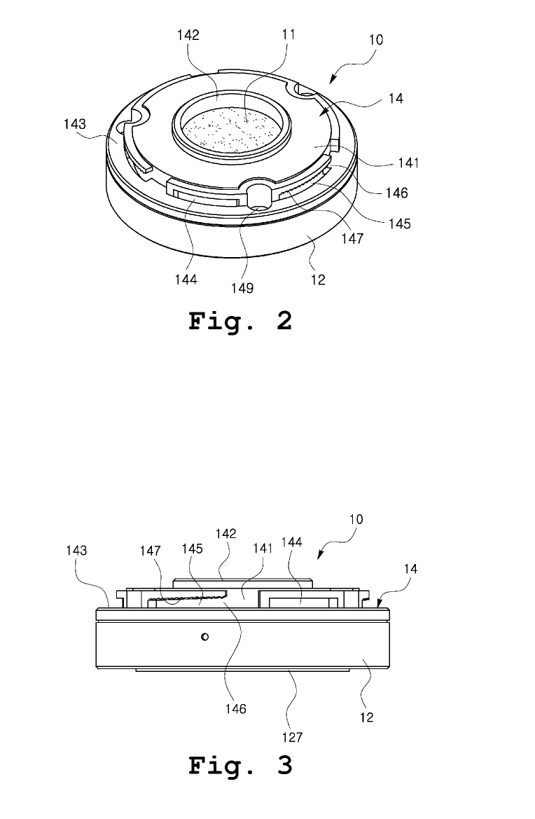

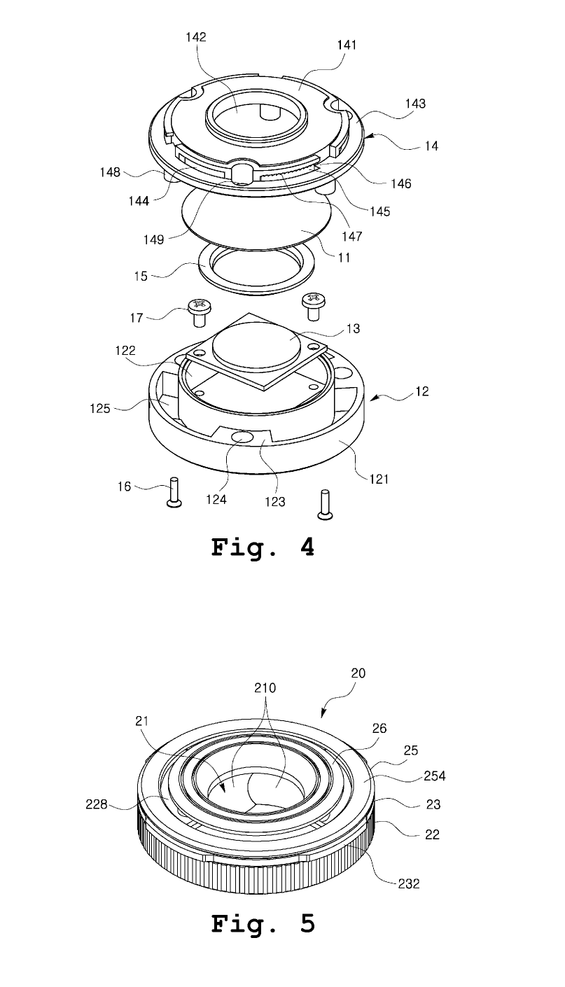

Now, the LED light source module 10 of the LED lamp 1 capable of freely converting color temperature in accordance with the embodiment of the present invention will be described with reference to FIGS. 2 to 4 which are a perspective view, a side view, and an exploded perspective view of the LED light source module 10.

In the illustrated example, the LED light source module 10 includes a heat sink 12, a COB (Chip on Board) 13, a fixed filter 11, and an upper cover 14. The heat sink 12 has a COB receiving part 122.

The LED light source module 10 has a plurality of LEDs (not illustrated) installed on the COB 13. The plurality of LEDs may include the same kind of white LEDs, blue LEDs, purple LEDs, or UV LEDs having a predetermined color temperature. The white LED may include a natural white LED having a color temperature of 5,500 to 8,000K or a cold white LED having a color temperature of 3,800 or 4,800, for example.

Furthermore, the fixed filter 11 is formed of transparent glass, fluorescent coating glass, fluorescent substance-containing molding resin, or fluorescent coating resin. Since a variety of fluorescent substances for exciting light are publicly known in the art, the detailed descriptions thereof are omitted herein.

The heat sink 12 includes a rim 121 and the COB receiving part 122. The heat sink 12 may be manufactured through a die casting process using a metal having excellent heat conductivity, such as aluminum or magnesium alloy. The upper cover 14 may be manufactured through an injection-molding process using thermoplastic or thermosetting resin.

In the illustrated example, the heat sink 12 has an inward protrusion 123 having a fixation hole 124 for fixing the upper cover 14 and a bottom part 125 having a fixation hole formed therein. No reference numeral is given to the fixation hole of the bottom part 125. The COB receiving part 122 may be formed to protrude upward from the bottom part 125, and have a concave part (not illustrated) formed at the bottom thereof. A bottom plate 127 covering the concave part may be fastened to the COB receiving part 122 through a fixing unit 16.

The COB 13 is mounted on the COB receiving part 122 through a fixing unit 17, for example, and the fixed filter 11 is mounted over the COB 13 with a buffer member 15 such as a silicon ring interposed therebetween.

The upper cover 14 includes a flange 143 and a protrusion 141 having a central opening 142 formed therein, and the protrusion 141 has a plurality of heat radiation holes 144 and one or more engagement holes 145 formed on the outer periphery thereof. The engagement hole 145 includes an open end 146 formed at one end thereof and a saw-tooth part 147 formed on the inner top surface thereof. The engagement hole 145 has a height which gradually decreases toward the inside from the open end 146.

A plurality of locking bosses 222 formed at the bottom of a rim 221 of an outer heat sink 22 of the color temperature conversion module 20 are inserted into the respective engagement holes 145. At this time, the locking bosses 222 are reliably fixed by the saw-tooth part 147.

FIGS. 2 to 4 illustrate that the heat radiation holes 144 and the engagement holes 145 are alternately positioned. However, the numbers and positions of the heat radiation holes 144 and the engagement holes 145 are selectively determined and not limited thereto.

The fixed filter 11 is stably and reliably fixed by the upper cover 14 and the buffer member 15.

The upper cover 14 may include a leg part 148 having a screw hole (not illustrated) formed therein. The screw hole is fixed by the fixing unit 16 fastened through the fixation hole formed in the bottom part 125 of the heat sink 12, and the fixation hole 149 of the upper cover 14 and the fixation hole 124 formed in the inward protrusion 123 of the heat sink 12 may be reliably coupled to each other by a separate fixing unit (not illustrated) from the top.

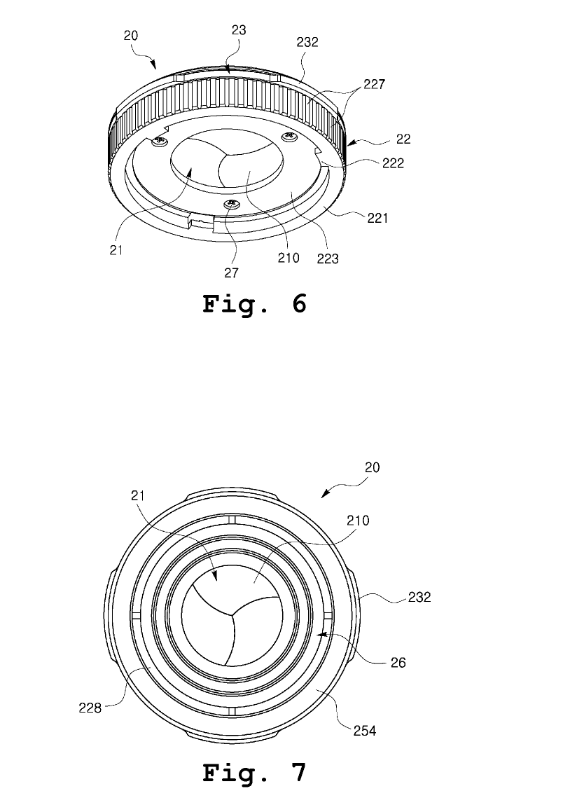

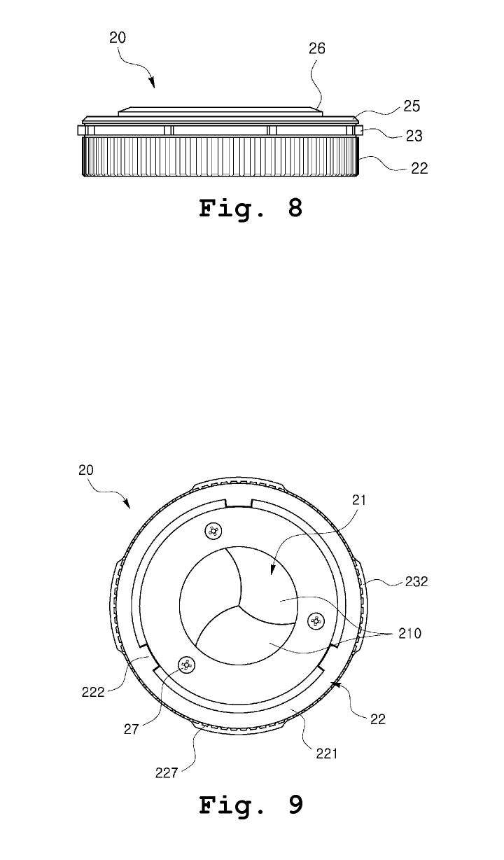

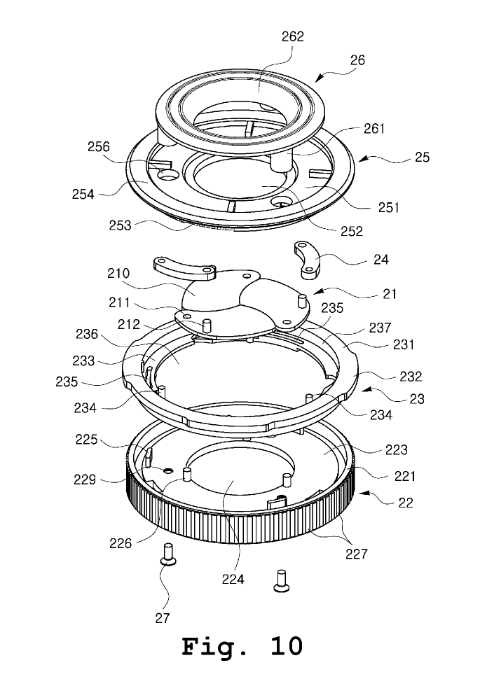

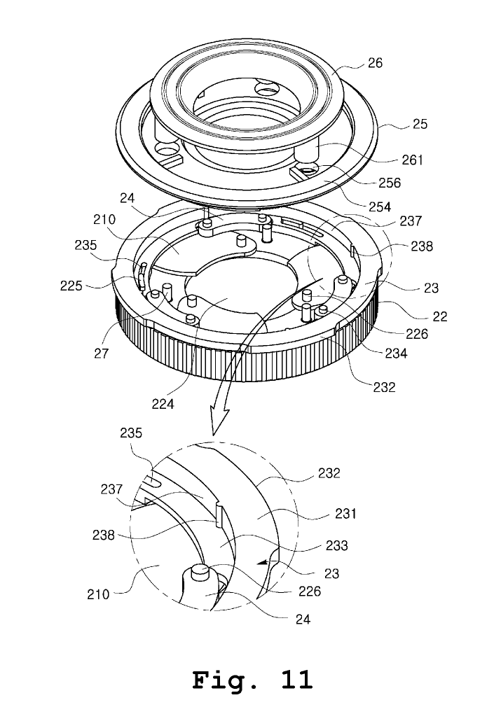

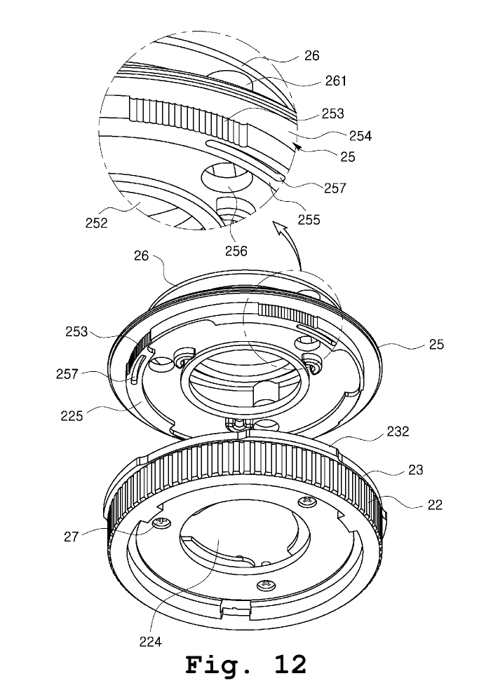

The color temperature conversion module 20 of the LED lamp 1 capable of freely converting color temperature in accordance with the embodiment of the present invention will be described in detail with reference to FIGS. 5 to 12. FIGS. 5 to 9 are a perspective view, a bottom perspective view, a plan view, a side view, and a bottom view of the color temperature conversion module 20, respectively. FIG. 10 is an exploded perspective view of FIG. 5, FIG. 11 is a partially exploded perspective view of FIG. 5, and FIG. 12 is a partially exploded perspective view of FIG. 5.

The color temperature conversion module 20 may include an outer heat sink 22, an inner heat sink 23, a cover 25, and a loop 26 as external components. Furthermore, the color temperature conversion module 20 may include the color temperature conversion filter 21, a link 24, and an arc-shaped horizontal protrusion 232 of the inner heat sink 23 as internal components. The color temperature conversion filter 21 may include a plurality of filter pieces 210, and the link 24 may control the color temperature conversion filter 21 to perform an aperture motion.

While the outer heat sink 22, the cover 25, and the loop 26 are reliably fixed by a fixing unit, the inner heat sink 23 having the arc-shaped horizontal protrusion 232 may be forward/backward rotated to control the color temperature conversion filter 21 to perform an aperture operation within a predetermined range, the color temperature conversion filter 21 including the plurality of filter pieces 210.

Between the outer periphery of the loop 26 and the inner periphery of the flange 154 of the cover 25, a space 228 for fastening the backlight module 30 may be formed. The backlight module 30 will be described below.

The inner and outer heat sinks 23 and 22 may be manufactured through a die casting process using a metal having excellent heat conductivity, such as aluminum or magnesium alloy. The cover 25 and the loop 26 may be manufactured through an injection-molding process using thermoplastic or thermosetting resin.

The outer heat sink 22 includes a rim 221 and a web 223. The rim 221 has a plurality of locking bosses 222 formed at the bottom thereof, and the web 223 has a first central opening 224 formed therein, a plurality of arc-shaped protrusions 225 formed at a predetermined distance from each other at the outer edge thereof, and a plurality of first fixing protrusions 226 formed at a predetermined distance from each other at the inner edge thereof.

The rim 221 may have a concave-convex surface 227 formed on the outer surface thereof, in order to improve the heat radiation characteristic. The drawings illustrate that the outer surface has a vertical round-type heat radiation fin structure. However, the shape of the outer surface is not limited thereto.

In the illustrated example, the web 223 includes a plurality of fixation holes 229 for fixing the cover 25 and the loop 26 through the fixing unit 27.

The inner heat sink 23 is mounted in the outer heat sink 22. The inner heat sink 23 includes an upper flange 231, an inward flange 233, and a ring-shaped sidewall 237. The upper flange 231 has a plurality of arc-shaped horizontal protrusions 232 positioned at a predetermined distance from each other. The inward flange 233 has a plurality of second fixing protrusions 234 positioned at a predetermined distance from each other, a plurality of arc-shaped guide slots 235 into which the respective arc-shaped protrusions 225 are inserted and which are positioned at a predetermined distance from each other, and a second central opening 236 formed therein. The ring-shaped sidewall 237 internally connects the inward flange 233 and the upper flange 231, and has one or more vertical protrusions 238 formed therein.

Through the plurality of arc-shaped horizontal protrusions 232 of the inner heat sink 23 protruding outward from the rim 221 of the outer heat sink 22, a user can forward/backward rotate the inner heat sink 23 with respect to the fixed outer heat sink 22 and the cover 25 within a predetermined range, using a hand or another driving unit.

The color temperature conversion filter 21 includes the plurality of filter pieces 210, and each of the filter pieces 210 has a hole 211 and a connection protrusion 212 which are formed at one end thereof. The first fixing protrusion of the outer heat sink 22 is inserted into the hole 211, and the connection protrusion 212 is coupled to one end of the link 24. The plurality of filter pieces 210 form an aperture structure.

In the present embodiment, the number and shape of the filter pieces 210 are not limited. The number may be selectively set in the range of 3 to 12, or specifically 3 to 8.

The plurality of links 24 form a ring shape as a whole. One end of the link 24 is linked to the connection protrusion 212 of the filter piece 210, and the other end of the link 24 is linked to the second fixing protrusion 234 formed on the inward flange of the inner heat sink 23.

The number of the links 24 corresponds to the number of the filter pieces 210.

The cover 25 includes a concave part 251 and a rail part 255. The concave part 251 has a third central opening 252 formed therein, one or more saw-tooth parts 253 formed on the outer periphery thereof, and a flange 254 formed at the top thereof. The saw-tooth part 253 is engaged with a vertical protrusion 238 of the inner heat sink 23. The rail part 255 is extended downward from the outer periphery of the bottom surface of the concave part 251 and then inward curved. The rail part 255 has a plurality of arc-shaped guide slots 257 into which the respective first fixing protrusions 226 of the outer heat sink 22 are inserted and which are spaced at a predetermined distance from each other.

The concave part 251 outside the third central opening 252 may have a plurality of fixation holes 256 formed at the bottom thereof.

The loop 26 has a fourth central opening 262 formed therein, and includes a plurality of leg parts 261 having a screw hole for fixation.

In the color temperature conversion module including the above-described components, the loop 26, the cover 25, and the outer heat sink 22 are fixed together by the fixing units 27 from the bottom of the outer heat sink 22 through the screw holes (not illustrated) formed in the leg parts 261 of the loop 26 and the fixation holes 256 of the cover 25. At this time, the inner heat sink 23 is supported to be forward/backward rotated within the length of the arc-shaped guide slots 235 and 257 of the inner heat sink 23 and the cover 25 through the arc-shaped horizontal protrusion 232 of the inner heat sink 23, in a state where the arc-shaped protrusion 225 of the outer heat sink 22 is inserted into the arc-shaped guide slots 235 and 257 of the inner heat sink 23 and the cover 25.

The forward/backward rotation of the arc-shaped horizontal protrusion 232 of the inner heat sink 23 operates the plurality of filter pieces 210 to perform an aperture motion through the respective links 24, each of which has one end linked to the connection protrusion 212 of the corresponding filter piece 210 and the other end linked to the second fixing protrusion 234 of the inner heat sink 23, around the first fixing protrusion 226 of the outer heat sink 22.

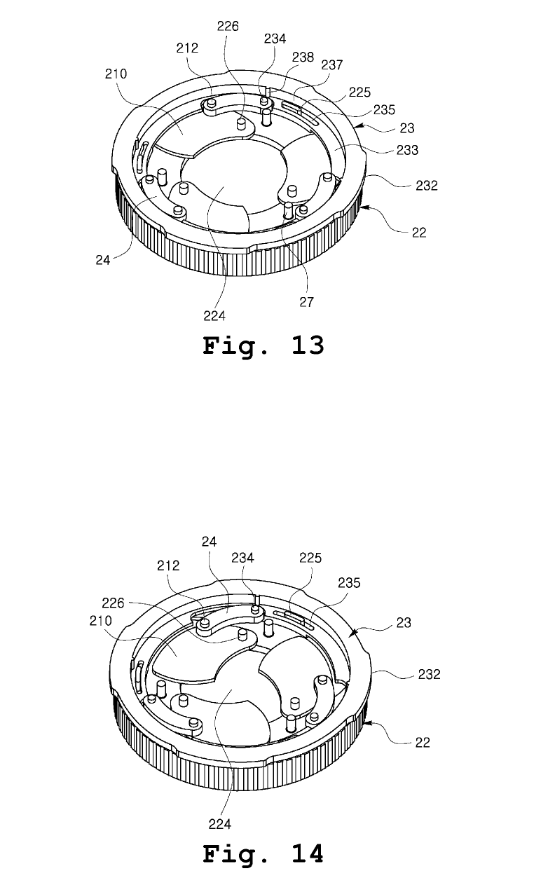

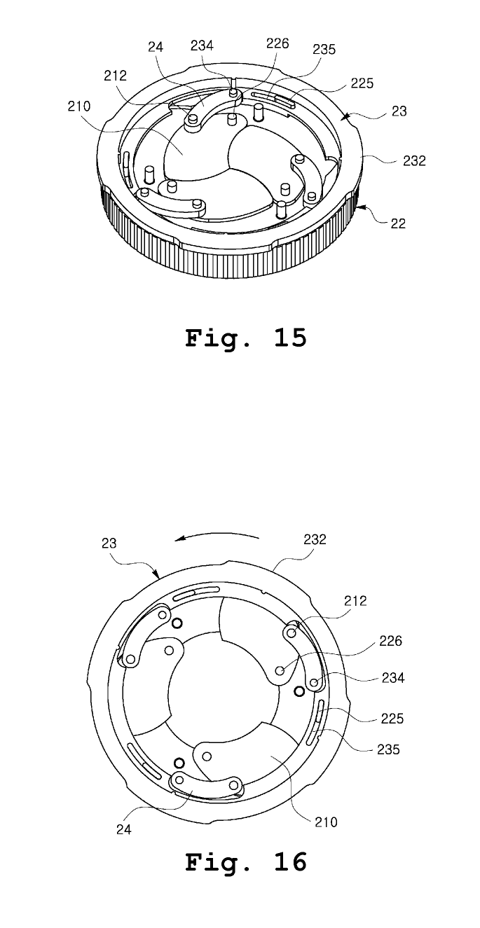

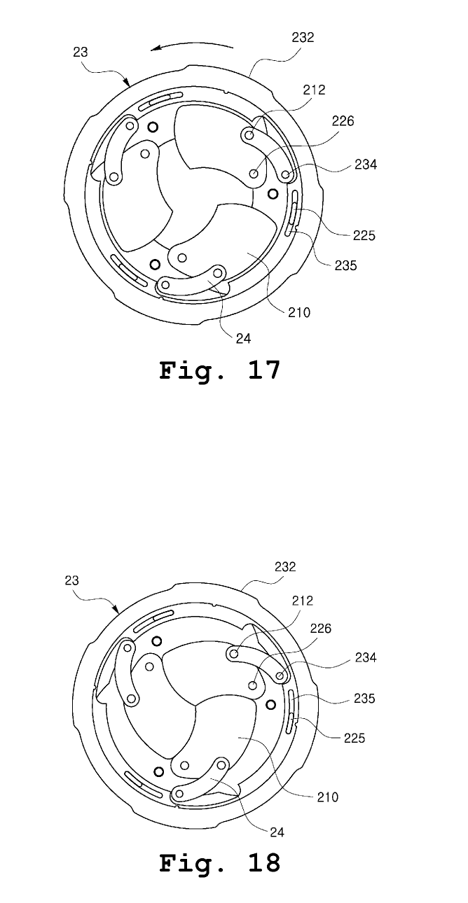

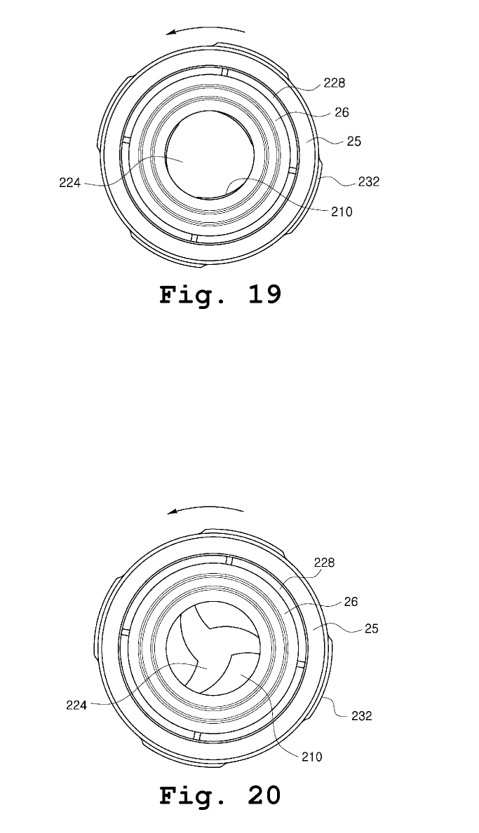

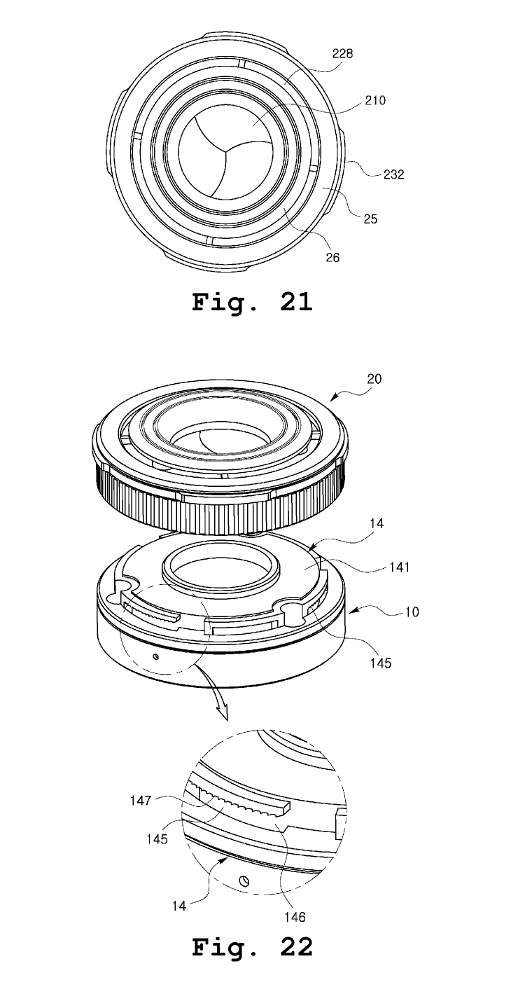

FIG. 13 is a perspective view illustrating a state in which the color temperature conversion filter 21 is opened to the maximum. FIG. 14 is a perspective view illustrating a state in which the color temperature conversion filter 21 is opened to an intermediate position. FIG. 15 is a perspective view illustrating a state in which the color temperature conversion filter 21 is closed. FIGS. 16 to 18 are plan views of FIGS. 13 to 15. FIGS. 19 to 21 are bottom views of FIGS. 13 to 15, illustrating states in which the upper cover is mounted. Referring to FIGS. 13 to 21, the aperture motion of the color temperature conversion filter 21 will be described.

Although FIGS. 13 to 21 do not illustrate the fixed filter 11 fixed to the LED light source module 10, the change of the overlap area between the fixed filter 11 and the color temperature conversion module 20 by expansion or reduction of the overlap area through the aperture motion of the color temperature conversion filter 21 of the color temperature conversion module 20 with respect to the fixed filter 11 causes a variation in color temperature through excitation of various fluorescent substances. Thus, when the LED light source module 10 emits natural white light having a color temperature of 5,500 to 8,000K, the color temperature of the light may be maintained in case where the color temperature conversion filter 21 is completely opened. However, the light can be converted into cold white light having a color temperature of 3,800 to 4,800K when the color temperature conversion filter 21 is opened to an intermediate position, or converted into warm white light having a color temperature of 2,300 to 3,500K when the color temperature conversion filter 21 is completely closed. When light emitted from the LED light source module 10 is cold white light having a color temperature of 3,800 to 4,800K, the light may be maintained in case where the color temperature conversion filter 21 is completely opened. However, as the opening degree is decreased, the color temperature can be lowered. When the color temperature conversion filter 21 is completely closed, the light can be converted into warm white light having a color temperature of 2,300 to 3,500K.

When the LED light source module 10 includes a white light LED, the fixed filter 11 may be formed of transparent glass or resin. When the LED light source module 10 includes a single-color LED such as a blue LED, the fixed filter 11 may be formed by applying a fluorescent substance for converting the single-color LED into a white light LED or uniformly mixing and molding a fluorescent substance.

As a result, the change of the overlap area based on the opening or closing degree of the color temperature conversion filter 21 with respect to the fixed filter 11 causes a variation in color temperature of illumination light. According to a situation desired by a user, illustration light in which warm white and cold white are mixed, illumination light in which cold white and natural white are mixed, or illumination light in which warm white and natural white are mixed and which has an arbitrary color temperature can be simply and easily implemented in real time.

Referring back to FIGS. 13 to 21, the aperture motion of the color temperature conversion filter 21 will be described as follows.

FIGS. 13, 16, and 19 illustrate a state in which the color temperature conversion filter 21 is completely opened. Referring to FIGS. 13, 16, and 19, the arc-shaped protrusion 225 of the outer heat sink 22 functions as a stopper and is positioned to be in contact with one end of the arc-shaped guide slot 235 of the inner heat sink 23. Thus, the inner heat sink 23 cannot be rotated in the clockwise direction any more.

In this state, the link 24, of which one end is linked to the connection protrusion 212 of the filter piece 210 and the other end is linked to the second fixing protrusion 234 of the inner heat sink 23, is received in the curved part formed in the inward flange 233 of the inner heat sink 23, and maintains substantially the same direction as the inner periphery of the inner heat sink 23.

FIGS. 14, 17, and 20 illustrate a state that a user slightly rotates the arc-shaped horizontal protrusion 232 of the inner heat sink 23 in the counterclockwise direction through a user's hand or another driving unit, such that the color temperature conversion filter 21 is opened to an intermediate position. Referring to FIGS. 14, 17, and 20, the arc-shaped protrusion 225 of the outer heat sink 22 is positioned in the middle of the arc-shaped guide slot 235 of the inner heat sink 23.

In this state, as the link 24 having one end connected to the second fixing protrusion 234 of the inner heat sink 23 are moved in the counterclockwise direction, the filter piece 210 is rotated about the first fixing protrusion 226 of the outer heat sink 22 serving as the central axis of rotation, and slightly inward moved. Thus, the connection protrusion 212 of the filter piece 210 is also slightly moved toward the center of the inner heat sink 23. As a result, the one end of the link 24 connected to the connection protrusion 212 is also rotated slightly inward.

FIGS. 15, 18, and 21 illustrate a state in which the user further rotates the arc-shaped horizontal protrusion 232 of the inner heat sink 23 in the counterclockwise direction through a user's hand or another driving unit, such that the color temperature conversion filter 21 is completely closed. Referring to FIGS. 15, 18, and 21, the arc-shaped protrusion 225 of the outer heat sink 22 serves as a stopper and is positioned to be in contact with the other end of the arc-shaped guide slot 235 of the inner heat sink 23. Thus, the inner heat sink 23 cannot be rotated in the counterclockwise direction any more, but can be rotated only in the clockwise direction for opening.

In this state, as the link 24 having one end connected to the second fixing protrusion 234 of the inner heat sink 23 is further moved in the counterclockwise direction, the filter piece 210 is rotated about the first fixing protrusion 226 of the outer heat sink 22 serving as the central axis of rotation, and further moved to the inside. Then, the one end of the link 24 connected to the connection protrusion 212 is rotated to the innermost position, and the plurality of filter pieces 210 are closed so as to be in contact with each other.

When the color temperature conversion filter 21 is completely closed, the link 24 cannot be rotated in the counterclockwise direction any more. Then, as the link 24 is rotated in the clockwise direction, the color temperature conversion filter 21 can be opened. The process is performed in the opposite order.

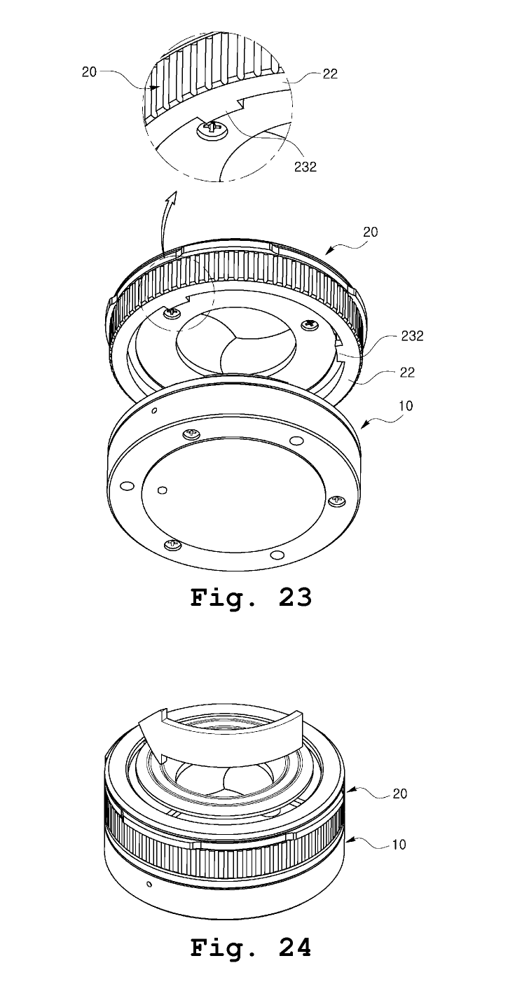

FIGS. 22 and 23 are diagrams illustrating a process in which the LED light source module 10 and the color temperature conversion module 20 are assembled. FIG. 22 is a perspective view, and FIG. 23 is a bottom perspective view. FIG. 24 is a perspective view illustrating a state in which the LED light source module 10 and the color temperature conversion module 20 are assembled.

As described above, the one or more engagement holes 145 are formed in the upper cover 14 of the LED light source module 10. The engagement hole 145 has an open end 146 formed at one end thereof and a saw-tooth part 147 formed on the inner top surface thereof. The engagement hole 145 has a height which gradually decreases toward the inside from the open end 146. Thus, when the locking boss 222 formed under the rim 221 of the outer heat sink 22 is positioned at the open end 146 and the outer heat sink 22 is rotated, the locking boss 222 may be reliably fixed by the saw-tooth part 147. As a result, the LED light source module 10 and the color temperature conversion module 20 may be reliably fixed to each other.

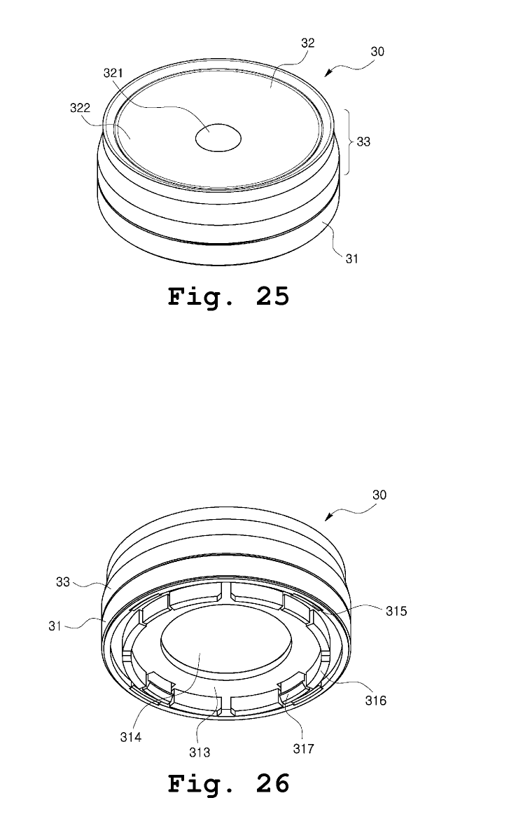

Then, referring to FIGS. 25 to 30, the backlight module 30 which is a selective component in the embodiment of the present invention will be described in detail.

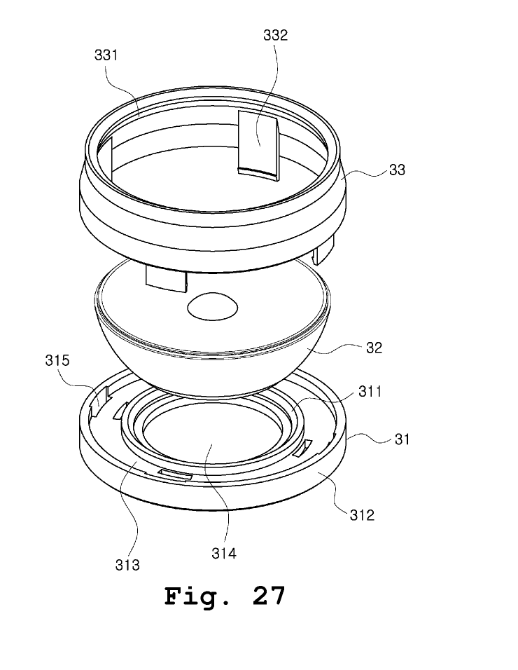

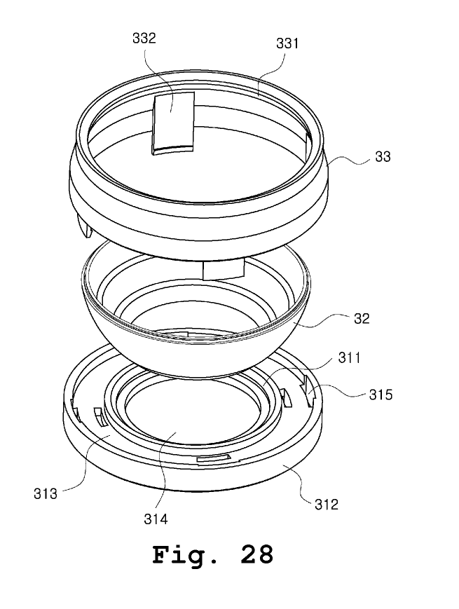

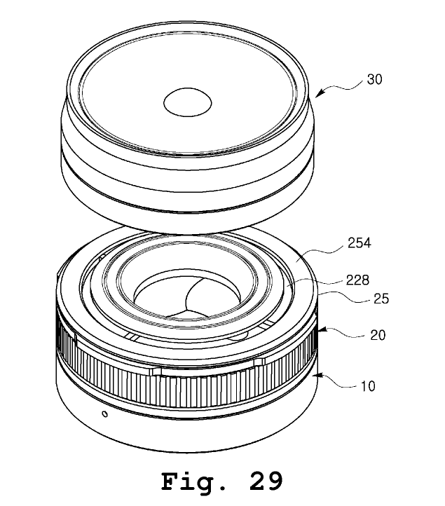

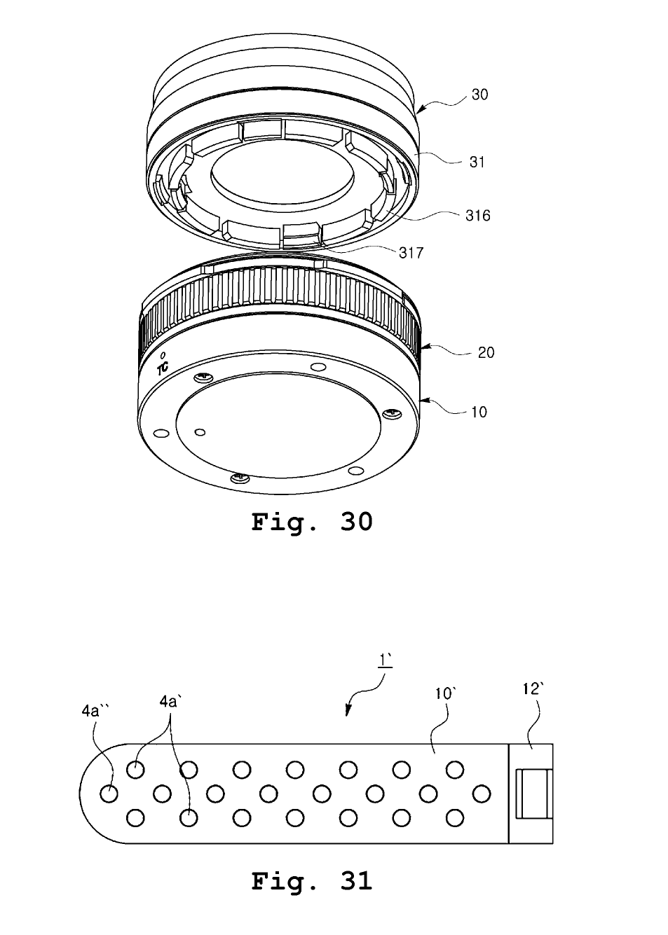

FIGS. 25 and 26 are a perspective view and bottom perspective view of the backlight module 30. FIGS. 27 and 28 are exploded perspective views when the backlight module 30 is a lens and a reflector, respectively. FIGS. 29 and 30 are a perspective view and bottom perspective view illustrating a state in which the backlight module 30 is assembled.

The backlight module 30 includes a bottom plate 31, a backlight member 32, and an upper fixing part 33. The bottom plate 31 and the upper fixing part 33 may be manufactured by an injection molding process using thermoplastic or thermosetting resin. However, the present invention is not limited thereto.

The bottom plate 31 includes a seat part 311 forming a central opening 314, a rim 312, and a web 313. The web 313 adjacent to the rim 312 has a plurality of through-slots 315 formed therein, and the web 313 has a plurality of arc-shaped protrusions 316 and locking bosses 317 which are radially formed on the bottom surface thereof.

As described above, the backlight member 32 may include a lens or reflector.

The upper fixing part 33 has a fixing stepped part 331 formed on the upper inner periphery thereof and a plurality of fastening pieces 332 extended downward. As the plurality of fastening pieces 332 are fastened to the bottom plate 31 through the through-slots 315 formed in the bottom plate 31, the backlight member 32 is reliably fixed.

When the backlight module 30 is a lens, the shape of the lens is not limited. Specifically, however, the lens may have a cross-sectional shape of which the upper part is wide but the lower part is narrow, and include a hemispherical concave part formed at the bottom thereof and a ring-shaped concave surface 322 having a hemispherical protrusion 321 formed in the top center thereof. The ring-shaped concave surface 322 has a structure of which the height increases from the outer periphery of the hemispherical protrusion 321 to the outer periphery of the top surface of the lens.

The backlight module 30 and the LED lamp 1 including the LED light source module 10 and the color temperature conversion module 20 may be coupled to each other through the following method. The arc-shaped protrusion 316 and the locking boss 317 formed on the bottom plate 31 of the backlight module 30 are inserted into the space 228 formed between the outer periphery of the loop 26 of the color temperature conversion module 20 and the inner periphery of the flange 254 of the cover 25, and the locking boss 317 is fastened to the inner bottom surface of the outer periphery of the loop 26. Then, the LED lamp 1a (refer to FIG. 10) is formed.

Now, a method for converting color temperature of the LED lamp in accordance with the embodiment of the present invention will be simply described.

Then, the method for converting color temperature of the LED lamp in accordance with the embodiment of the present invention may include the following steps.

(A) Step of assembling the LED light source module and the color temperature conversion module:

The LED light source module 10 including the fixed filter 11 mounted therein and having a constant color temperature is assembled to the color temperature conversion module 20 including the color temperature conversion filter 21.

(B) Step of converting color temperature

The overlap region between the fixed filter 11 and the color temperature conversion filter 21 is gradually expanded or reduced to implement illumination light having a desired color temperature.

The expansion or reduction of the overlap region between the fixed filter 11 and the color temperature conversion filter 21 at the step B may be performed through the aperture motion of the color temperature conversion filter 21.

### INDUSTRIAL APPLICABILITY

The LED lamp capable of freely converting color temperature and the method for converting color temperature of the LED lamp in accordance with the embodiment of the present invention can simply and freely convert the color temperature of a single-color or white LED having a constant single color temperature into white light having a desired color temperature and color rendering property, using the function of the LED lamp, without using a complex combination of LEDs having various color temperatures. Thus, since the LED lamp has high user convenience and economical efficiency, the LED lamp can be effectively applied to various lamps such as residential or commercial lamps, vehicle lamps, and studio lamps.

1-4. (canceled)

5. An LED lamp comprising:
an LED light source module including a fixed filter mounted therein and having a constant color temperature; and
a color temperature conversion module,
wherein the color temperature conversion module comprises:
an outer heat sink including a web having a first central opening formed therein, a plurality of arc-shaped protrusions formed at an outer edge thereof so as to be spaced from each other, and a plurality of first fixing protrusions formed at an inner edge thereof so as to be spaced from each other;
an inner heat sink including: an upper flange having a plurality of arc-shaped horizontal protrusions spaced from each other; an inward flange having a plurality of fixing protrusions spaced from each other, a plurality of arc-shaped guide slots into which the respective arc-shaped protrusions are inserted, and a second central opening formed therein; and a ring-shaped sidewall integrally connecting the inward flange and the upper flange and having one or more vertical protrusions formed therein, wherein the plurality of arc-shaped vertical protrusions are mounted in the outer heat sink so as to protrude to the outside of a rim;
a color temperature conversion filter including a plurality of filter pieces to form an aperture structure, wherein each of the filter pieces has a connection protrusion and a hole into which the first fixing protrusion is inserted, and the connection protrusion and the hole are formed at one end of the filter piece;
a plurality of links connecting the connection protrusions of the plurality of filter pieces to the plurality of second fixing protrusion, respectively; and
a cover having a concave part and a flange formed at the top of the concave part, the concave part having a third central opening formed therein and including one or more saw-tooth parts formed on the outer periphery of the sidewall thereof and, the one or more saw-tooth parts being engaged with the one or more vertical protrusions,
wherein the outer heat sink, the cover, and the loop are fixed together by a fixing unit,
the inner heat sink is forward/backward rotated within the length of the arc-shaped guide slot of the inner heat sink, into which the arc-shaped horizontal protrusion of the outer heat sink is inserted,
the forward/backward rotation of the inner heat sink is precisely adjusted through engagement between the vertical protrusions of the inner heat sink and the saw-tooth parts of the cover, and
through an aperture motion of the plurality of filter pieces connected to the first fixing protrusions of the outer heat sink and the second fixing protrusions of the inner heat sink based on the forward/backward rotation of the inner heat sink, an overlap region between the fixed filter of the LED light source module and the color temperature conversion filter of the color temperature conversion module is gradually expanded and reduced to freely convert color temperature.

6. The LED lamp of claim 5, wherein the cover comprises a rail part having a plurality of arc-shaped guide slots into which the respective first fixing protrusions are inserted and which are spaced from each other, and the rail part is extended downward from the outer periphery of the bottom surface of the concave part and then inward curved.

7. The LED lamp of claim 5, wherein the loop is fastened to the top of the cover.

8. The LED lamp of claim 7, wherein a space is formed between the outer periphery of the loop and the inner periphery of the flange of the cover.

9. (canceled)

10. The LED lamp of claim 5, wherein the LED light source module comprises a white LED, a blue LED, a purple LED, or a UV LED.

11. The LED lamp of claim 5, wherein the fixed filter is formed of transparent glass, fluorescent coating glass, fluorescent substance-containing molding resin, or fluorescent coating resin, and the color temperature conversion filter is formed of fluorescent substance-containing molding resin or fluorescent coating resin.

12. The LED lamp of claim 5, wherein the LED light source module comprises a heat sink having a COB (Chip on Board) receiving part, a COB, the fixed filter, and an upper cover.

13. The LED lamp of claim 12, wherein the heat sink has a rim and the COB receiving part,
the upper cover has a flange and a protrusion having a central opening formed therein,
the protrusion has a plurality of heat radiation holes and one or more engagement holes formed on the outer periphery thereof, the engagement hole including an open end formed at one end thereof and a saw-tooth part formed on the inner top surface thereof and having a height which gradually decreases from the open end toward the inside thereof, and
the plurality of locking bosses formed at the bottom of the rim of the outer heat sink of the color temperature conversion module are inserted into the engagement holes and reliably fixed by the saw-tooth part.

14. The LED lamp of claim 13, wherein the heat sink comprises an inward protrusion having an upper cover fixation hole, a bottom part having a fixation hole formed therein, and a bottom plate.

15. (canceled)

16. The LED lamp of claim 5, further comprising a backlight module,
wherein the backlight module comprises:
a bottom plate having a seat part forming a central opening, a rim, a web, and a plurality of through-slots formed in the web adjacent to the rim;
a backlight member; and
an upper fixing part having a fixing stepped part formed on the upper inner periphery thereof and a plurality of fastening pieces extended downward and fixed to the bottom plate through the plurality of through-slots so as to fix the backlight member.

17. (canceled)

18. The LED lamp of claim 16, wherein the backlight module comprises a lens, and
the lens has a cross-sectional shape of which the upper part is wide and the lower part is narrow, and includes a hemispherical concave part formed at the bottom thereof and a ring-shaped concave surface including a hemispherical protrusion formed in the top center thereof and having a structure of which the height increases from the outer periphery of the hemispherical protrusion toward the outer peripheral end of the top surface of the lens.

19-20. (canceled)
